(19) United States
(12) Patent Application Publication
(10) Pub. No.: US 2007/0109695 A1
(43) Pub. Date: May 17, 2007

(54) Multiple UL class II secondary power sources

(75) Inventor: James Newlon, Kokomo, IN (US)

Correspondence Address: ICE MILLER LLP, ONE AMERICAN SQUARE, SUITE 3100, INDIANAPOLIS, IN, 46282-0200, US

(73) Assignee: Functional Devices, Inc., Russiaville, IN (US)

(21) Appl. No.: 11/273,988

(22) Filed: Nov. 15, 2005

(51) Int. Cl. H02H 7/04

(52) U.S. Cl. 361/38

(57) ABSTRACT

A transformer comprising multiple secondary circuits operable to provide less than 250 VA of output per secondary circuit when an external over-current protection device is bypassed, and no more than about 100 VA of output when the external over-current protection device is not bypassed.

### BACKGROUND

The present invention relates to improvements in transformers, and more particularly to methods of producing a non-inherently limited transformer with multiple secondary capable of meeting the listing requirements of Underwriters Laboratories Inc (“UL”) for Class 2 power sources. In addition, the structures disclosed below may be used to meet other requirements of various regulatory bodies.

Most electrical appliances today utilize a transformer to either step up or step down the voltage and/or amperage from the power source to provide the proper voltage and amperage to the appliance. Transformers utilize both primary and secondary windings to convert an input electrical power from a power source across the primary winding to an output potential in the secondary winding that is higher than, lower than, or equal that of the power source. For instance, a transformer may take a 120 volt AC current and convert it to a 3 volt AC current by using a primary with forty (40) times the windings in the primary windings than that of the secondary windings. As the laws of physics dictate the voltage output of the transformer described above will be forty (40) times less than the input voltage, and the maximum power output can be adjusted by the internal wiring. The output limited by the windings and the wire selection are referred to as the inherent limitation of a transformer. Using this, one can calculate the maximum power output of the circuit connected to the secondary winding (“secondary circuit”) when a range of maximum voltages and/or currents is applied across the circuit of the primary winding; and the maximum power can be controlled.

In many cases, transformers are used to step down the voltage to various circuits in order to provide a potential across the circuit that would be less hazardous to any individual that may come in contact with the circuit. Indeed, there are many regulatory bodies that provide a specific set of standards for a particular application, and those regulatory bodies may require certain testing facilities to approve of any given transformer for a particular application.

For instance, the National Electrical Code (“NEC”) establishes safety requirements for electrical wiring in the United States. Many municipalities may require a portion of wiring within public buildings to meet NEC Class 2 standards, requiring transformers used therein to be listed by a testing facility as Class 2, such as the Underwriters Laboratories, Inc. The Class 2 rating is intended to provide a set of criterion for identifying power circuits and appliances, which are limited in voltage, amperage and total power to be nonhazardous. In particular, a Class 2 circuit must be supplied by a limited power source such as a transformer. A Class 2 transformer must not supply more than 100 VA from a single output under normal running conditions.

Class 2 transformer outputs, as tested to the UL's UL1585 standard, must be power-limited in one of two ways. The secondary circuit output of a transformer must be either (1) inherently limited to 100 VA output, in which case an external over-current protection device is not required, or (2) non-inherently limited (if inherent limiting cannot be accomplished) and must have external over-current protection limiting output to a specified power, and must not exceed 250 VA when the external over-current protection device is bypassed. Said differently, one of the requirements of a non-inherently-limited Class 2 transformer is that it must not supply more than 250 VA from a single output under a full range of loads when its rated voltage is provided across the primary, and even with the external over-current protection bypassed.

Typically, limiting the maximum power output in a transformer to 250 VA has been accomplished by adjusting the number of turns in the primary or secondary windings, or the size of the wire in the primary or secondary windings to ensure that the output of the secondary windings cannot exceed the 250 VA output over the full range of loads.

Further, developing a transformer capable of producing multiple secondaries having relatively high power outputs (for example, five (5) 100 VA secondaries) often requires increased wire size to allow sufficient power to each of the secondaries. Further, in many cases, it may be preferable from a manufacturing standpoint to utilize a primary and secondary winding that are manufactured from a wire of identical gauge. Therefore, it is impracticable to create a transformer with multiple secondaries with substantial power outputs that are inherently limited to 250 VA power, because it is difficult to create a cost-effective combination of wire size and turnings within secondary windings that both (1) allows a substantial working power output to multiple secondaries (for instance, 100 VA) while (2) inherently limiting the maximum power output to 250 VA.

Due to the difficulties and impracticability of providing Class 2 listed output to multiple secondary circuits, a previous solution to providing multiple outputs rated at a particular power and voltage output was accomplished by providing multiple transformers having single secondary outputs to meet UL Class 2 listing requirements. However, the use of multiple individual transformers increases the cost as well as the space required to provide the needed power output to Class 2 circuits. Additionally, other means of achieving multiple high output secondary power sources include the use of a single secondary with an extremely high output divided into multiple fuses and switches in the secondary circuit to limit the load at each switch. However, such a transformer does not meet UL Class 2 listing requirements, and therefore cannot be used in many applications. Therefore, because a reduced cost and space savings in a Class 2 listed device would be greatly appreciated in the art, a transformer having multiple secondary outputs providing substantial power to circuits would be greatly appreciated in the art.

### SUMMARY

The present invention relates to a transformer having over-current protection. In particular, the present invention relates to a transformer with over-current protection and having the following structures: (1) one or more primary windings which can be connected across an electrical power source; (2) more than one secondary windings electromagnetically coupled to the one or more primary windings and operable to carry an electric load; (3) at least one embedded over-current protection device that is embedded in one or more of the secondary windings; and (4) at least one external over-current protection device that is external to the transformer.

In addition, the present invention may optionally have at least one external over-current protection device that is situated on each circuit associated with a secondary winding. Further, the primary winding of the transformer may be operable to transmit at least 101 VA of power. Optionally, each secondary winding may include an embedded over-current protection device, and each embedded over-current protection device may limit the output of the secondary winding circuit to a maximum output. According to one embodiment of the present invention, the maximum output allowed by the over-current protection device may be selected from a range of about 101 VA to about 250 VA. Another option according to one embodiment would be to utilize an external over-current protection device on each circuit associated with a secondary winding so that the current limitation when the external over-current protection device is lower than the current limitation provided by the embedded over-current protection device.

In addition, one could optionally utilize an external over-current protection device that is selected from a range of about 0 VA to about 100 VA output limitation. For example, one transformer could be selected with a primary winding operable to provide 500 VA output. Optionally, that transformer could contain five separate secondary windings so that five secondary circuits could provide output. Further, those five secondaries could each contain an embedded over-current protection device to limit the output of each winding to 250 VA. Optionally, the over-current protection device could be a PTC. Further, an external over-current protection device could be placed on each secondary circuit to limit the output of each secondary circuit to 100 VA.

In another example, one transformer could be selected with a primary winding operable to provide 300 VA output. Optionally, that transformer could contain three separate secondary windings so that three secondary circuits could provide output. Further, those three secondaries could each contain an embedded over-current protection device to limit the output of each winding to 250 VA. Optionally, the over-current protection device could be a PTC. Further, an external over-current protection device could be placed on each secondary circuit to limit the output of each secondary circuit to 100 VA.

### BRIEF DESCRIPTION OF THE DRAWINGS

FIG. 1 is a wiring diagram displaying one embodiment of the present invention.

### DESCRIPTION

The present invention relates to power transformers. In particular, the present invention relates to power transformers with multiple outputs.

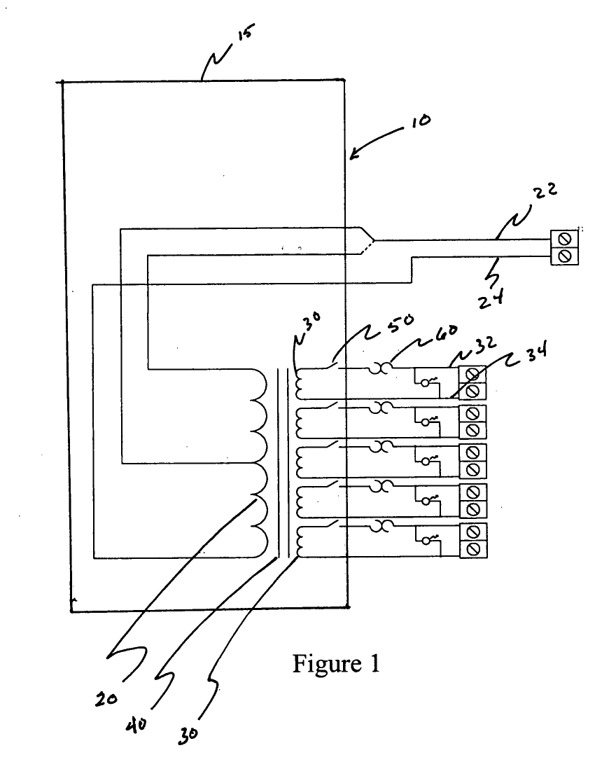

Referring now to FIG. 1, according to one aspect of the present invention, a transformer 10 comprises at least one primary winding 20 having leads 22 and 24 for connection with a power source, and more than one secondary winding 30 having leads 32 and 34 across which a secondary load may flow. The primary winding 20 and secondary winding 30 are joined to a core 40. In addition, transformer 10 comprises at least one over-current protection device 50 such as a positive temperature coefficient thermistor (“PTC” or “polyfuse”) (such as those offered by the Raychem division of Tyco Electronics Corporation, 300 Constitution Drive, Menlo Park, Calif. under the Polyswitch® brand name) embedded in each secondary winding of transformer 10. Further, according to another aspect of the present invention, an additional over-current protection device 60 is located external to the packaged transformer.

According to one aspect of the present invention, the at least one over-current protection device may be embedded within the windings of the transformer. An over-current protection device may comprise a fuse, thermal circuit breaker, thermal fuse, PTC, or any other over-current protection device well known in the art. For example, a PTC may be embedded within the primary or secondary windings (or both), causing that particular circuit to break when the current through the winding exceeds the predetermined limit of the PTC. Therefore, use of an over-current protection device embedded within the at least one primary windings limits the output of each of the secondary winding(s) associated with the at least one primary windings with an embedded PTC, as the source current ceases when the primary winding circuit is broken. Therefore, all output from the secondary windings related to the broken primary winding circuit.

According to another embodiment of the present invention, an over-current protection device may be embedded within one or more secondary winding or each secondary winding in the transformer. Optionally, the over-current protection device embedded in each secondary winding can be the same over-current protection device in all secondary circuits, can be a different over-current protection device for each secondary winding, or can be any combination of similar or different over-current protection devices for each secondary winding. In addition, according to one embodiment of the present invention, each over-current protection device provided can be rated to activate (break the circuit) at a selected current maximum. Further, each over-current protection device may be selected to activate at a different current maximum from each other external over-current protection device; or there can be a combination of over-current protection devices wherein a number are selected to activate at a first current while a second number are selected to activate at a second current, and so on. In this manner, each secondary circuit can be limited to one particular current or power or each secondary circuit may be limited to varying currents or powers.

In another embodiment of the present invention, embedded over-current protection devices and primary and secondary windings may be included in a housing 15 as shown in FIG. 1. Also, housing 15 may be expanded to encompass some or all of the components shown in FIG. 1. Embedded over-current protection devices according to the present invention are not typically used due to the fact that an over-current protection device embedded within the transformer may not be easily accessible in the event of activation. In addition, embedding certain over-current protection devices within the windings may render the transformer unusable or impracticable to repair, reactivate, or use once the over-current protection device has been activated. Further, in the instances where secondary output must be limited to a maximum power output, transformers used in the art typically limit maximum current of the secondary circuits through adjustment in internal resistance. This is typically done by adjusting the wire size selection and number of windings to inherently limit the output of the secondary circuits across a range of inputs from a power source.

However, according to one embodiment of the present invention, power output for each secondary circuit may be limited by simply using an embedded over-current protection device without altering wire size, thereby increasing flexibility in design and manufacturing of transformers.

According to another embodiment of the present invention, in addition to an embedded over-current protection device, an external over-current protection device may be installed on each or certain of the circuits from the secondary windings or primary windings. For example, an external circuit breaker or thermal breaker may be placed in a series with the embedded over-current protection device, providing additional over-current protection to the circuit. According to one aspect of the present invention, the external circuit breaker is selected to activate, thereby breaking the circuit, when the current through the circuit is at a level lower than that of the embedded over-current protection device embedded in the winding of the same circuit. Thus, in one embodiment, the external over-current protection device is selected to activate at a current maximum that is lower than the embedded over-current protection device, thereby reducing the need for the embedded over-current protection device unless the external protection device fails. Further, according to another embodiment of the present invention, the external protection device is an over-current protection device that can be easily re-set after activation, such as a circuit breaker or recycling circuit breaker, thereby allowing use of the circuit even after the circuit has exceeded the maximum current of the external over-current protection, once the activated over-current protection device has been re-set.

For example, an external over-current protection device may be selected to further limit the output on any circuit associated with a secondary winding. For example, if an embedded over-current protection device limits the maximum output of a secondary winding to 250 VA, an external over-current protection device may limit the maximum output of the circuit associated with that secondary winding to a maximum output below 250 VA. In one embodiment, the external protection device may limit the maximum output to below about 100 VA such that the secondary output falls within UL Class 2 listing specifications. Therefore, should the external over-current protection device become bypassed, the embedded over-current protection device would limit the output of the secondary winding to 250 VA.

According to another exemplary embodiment of the present invention, a transformer comprises a certain gauge primary winding and five separate gauge secondary windings of the same gauge operable to supply 100 VA of power across each of its secondary circuits. For example, the primary and secondary windings may both be 15 gauge. It will be appreciated that the ability to use the same gauge wire for the primary winding and the secondary winding increases economies in manufacturing of the transformer. Each of the five secondary windings contains an embedded over-current protection device such as a PTC rated at 250 VA or less, or rated between about 101 VA and about 250 VA. In addition, each of the secondary circuits contains an external over-current protection device such as a circuit breaker or thermal circuit breaker rated up to about 100 VA. Therefore, if any one of the secondary circuits exceeds the rated 100 VA, the external over-current protection device is activated. However, if the external circuit breaker on any one of those secondary circuits fails, and the current meets or exceeds about 250 VA, the embedded over-current protection device is activated. Optionally, the external over-current protection device is located remotely from the transformer such that the external over-current protection device may be re-set without accessing the transformer. Conversely, the external over-current protection device may be located on the exterior of the transformer housing.

What is claimed is:

1. A transformer with over-current protection comprising:
a. at least one primary winding operable to be connected across an electrical power source;
b. more than one secondary winding electromagnetically coupled to the at least one primary winding and operable to carry an electric load;
c. at least one embedded over-current protection device embedded within at least one of the more than one secondary windings; and
d. at least one external over-current protection device external to the transformer.

2. The transformer of claim 1 wherein at least one external over-current protection device is situated on each circuit connected to the more than one secondary windings.

3. The transformer of claim 1 wherein the at least one primary winding is operable to transmit at least 101 VA of power.

4. The transformer of claim 3 wherein each secondary winding includes one of the embedded over-current protection device.

5. The transformer of claim 4 wherein each embedded over-current protection device is rated to activate when electric power in the secondary winding exceeds a maximum amount.

6. The transformer of claim 5 wherein the maximum amount is selected from a range of about 101 VA to about 250 VA.

7. The transformer of claim 5, wherein the at least one external over-current protection device is connected to each circuit in electrical connection with the more than one secondary winding.

8. The transformer of claim 7, wherein the at least one external over-current protection device is rated to activate when electric current in the secondary winding exceeds a maximum amount.

9. The transformer of claim 8, wherein the maximum amount for the at least one external over-current protection device is less than the maximum amount for the at least one internal over-current protection device.

10. The transformer of claim 9, wherein the maximum amount for the at least one external over-current protection device is selected from a range of more than 0 VA to about 100 VA.

11. The transformer of claim 1, wherein the at least one primary winding is operable to provide 500 VA of output.

12. The transformer of claim 11, wherein the more than one secondary windings comprises five secondary windings.

13. The transformer of claim 12, wherein the at least one external over-current protection device comprises one external over-current protection device connected to a circuit completing each of the five secondary windings, and operable to limit the output of each circuit to no more than about 100 VA.

14. The transformer of claim 13, wherein the at least one embedded over-current protection device comprises one embedded over-current protection device within each of the five secondary windings, and operable to limit the output of each circuit to between about 100 VA and about 250 VA.

15. The transformer of claim 1, wherein the at least one primary winding is operable to provide 300 VA of output.

16. The transformer of claim 15, wherein the more than one secondary windings comprises three secondary windings.

17. The transformer of claim 16, wherein the at least one external over-current protection device comprises one external over-current protection device connected to a circuit completing each of the three secondary windings, and operable to limit the output of each circuit to no more than about 100 VA.

18. The transformer of claim 17, wherein the at least one embedded over-current protection device comprises one embedded over-current protection device within each of the three secondary windings, and operable to limit the output of each circuit to between about 100 VA and about 250 VA.
